(19) United States
(12) Patent Application Publication
(10) Pub. No.: US 2026/0211807 A1
(43) Pub. Date: Jul. 23, 2026

(54) METHODS AND SYSTEMS FOR TIME SHIFT BUFFER OPTIMIZATION

(71) Applicant: DISH Network Technologies India Private Limited, Karnataka (IN)

(72) Inventors: Sandeep Kumar Bhatta, Karnataka (IN); Himanshu Jain, Karnataka (IN)

(21) Appl. No.: 19/035,709

(22) Filed: Jan. 23, 2025

(51) Int. Cl. G06F 12/02

(52) U.S. Cl. CPC G06F 12/023

(57) ABSTRACT

The present disclosure is directed to systems and methods for time shift buffer optimization. The time shift buffer (TSB) optimization system can utilize one or more machine learning or artificial intelligence algorithms to predict which channels the user will utilize a TSB. Based on this determination, the TSB optimization system can start recording content on the TSB a time threshold before the user is predicted to begin watching a channel.

### BACKGROUND

A user can pause a live television channel and resume watching the channel later by using a time shift buffer (TSB). The content of the live television channel is stored on a storage device while the channel is paused. In a multi-dwelling unit system, the storage capacity of the storage device can become overloaded as multiple users use the TSB for multiple channels. Limited storage can cause a degraded user experience and restrict the user's ability to utilize the TSB capability.

### BRIEF DESCRIPTION OF THE DRAWINGS

FIG. 1 illustrates an example of a distributed system for time shift buffer optimization, in accordance with one or more embodiments of the present technology.

FIG. 2 illustrates an example input processing system for implementing systems and methods for time shift buffer optimization, in accordance with one or more embodiments of the present technology.

FIG. 3 is a flow diagram illustrating a process used in some implementations for training a machine learning model to determine time shift buffer operations, in accordance with one or more embodiments of the present technology.

FIG. 4 is a flow diagram illustrating a process used in some implementations for operating a time shift buffer, in accordance with one or more embodiments of the present technology.

FIG. 5 is a flow diagram illustrating a process used in some implementations for determining the amount of storage for a time shift buffer, in accordance with one or more embodiments of the present technology.

FIG. 6 is a diagram illustrating an example system for optimizing time shift buffer operations, in accordance with one or more embodiments of the present technology.

FIG. 7 illustrates an example environment of operation of the disclosed technology.

FIG. 8 illustrates one example of a suitable operating environment in which one or more of the present embodiments may be implemented.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to systems and methods for time shift buffer optimization. A user can pause a live television channel and resume watching the channel later by using a time shift buffer (TSB). The TSB records the content of the live television channel for a pre-determined amount of time, such as 60 minutes. For example, the user has a 60-minute window to resume watching the paused content of the live channel. The TSB can store the recorded content locally, such as on a hard drive, or at a server. In some embodiments, the TSB optimization system is for a multi-dwelling unit (MDU) and users at the MDU can share TSB resources. Examples of an MDU can include an apartment building, apartment complex, hotel, retirement community, hospital, dormitory, or similar buildings or facilities.

The TSB optimization system can analyze the watch history of a user to determine parameters, such as the type of content the user watches, when a user watches each type of content, how long the user watches each type of content, the type of content the user utilizes the TSB, which channels the user utilizes the TSB, etc. The TSB optimization system can utilize one or more machine learning or artificial intelligence algorithms to predict which channels the user will utilize the TSB. For example, the TSB optimization system analyzes a user's behavior and determines that a user utilizes the TSB when consuming content on a sports channel but does not use the TSB when consuming content on a news channel. Based on this determination, the TSB optimization system can start recording content on the TSB a time threshold before the user is predicted to begin watching a channel.

The TSB optimization system can optimize the storage resources (e.g., memory, conventional hard disk, a solid-state drive (SSD), a hard disk drive (HDD), a USB, server storage, or any type of storage). By analyzing historical usage patterns and user behavior, the TSB optimization system may anticipate when TSB functionality will be needed and pre-allocate storage accordingly. This predictive approach may allow the TSB optimization system to dynamically adjust storage allocation based on expected demand, potentially freeing up resources when TSB usage is less likely. For instance, if the TSB optimization system predicts that a user typically uses the TSB for evening sports broadcasts but rarely for daytime programming, it may allocate more storage resources during peak evening hours and less during off-peak times. Additionally, the system may prioritize storage allocation for channels or content types that have a higher likelihood of TSB usage, ensuring that resources are available when they are most likely to be needed. This predictive optimization may help balance storage needs across multiple users in an MDU setting, maximizing the utility of available storage resources while minimizing the risk of storage overload during high-demand periods. The TSB optimization system can be executed by a user device (e.g., a STB or DVR), a server, or a combination thereof.

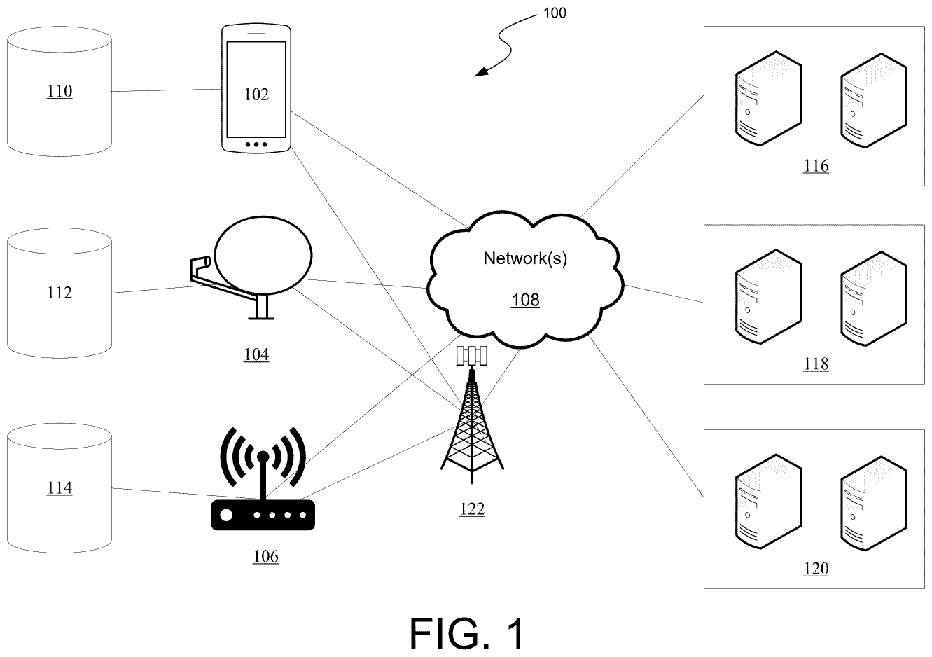

FIG. 1 illustrates an example of a distributed system for optimizing storage of recorded media content, in accordance with one or more embodiments of the present technology. Example system 100 presented is a combination of interdependent components that interact to form an integrated whole for TSB optimization. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and 106 may be configured to support determining the channel(s) that the user utilizes the TSB and how to optimize the storage resources of the TSB at an MDU. In one example, a client device 102 may be a mobile phone, a client device 104 may be a smart OTA antenna, and a client device 106 may be a broadcast module box (e.g., set-top box). In other example aspects, client device 106 may be a gateway device (e.g., router) that is in communication with sources, such as ISPs, cable networks, internet providers, or satellite networks. Other possible client devices include but are not limited to tablets, personal computers, televisions, etc. In aspects, a client device, such as client devices 102, 104, and 106, may have access to a network from a gateway. In other aspects, client devices 102, 104, and 106, may be equipped to receive data (e.g., instructions from a server) from a gateway. The signals that client devices 102, 104, and 106 may receive may be transmitted from satellite broadcast tower 122. Broadcast tower 122 may also be configured to communicate with network(s) 108, in addition to being able to communicate directly with client devices 102, 104, and 106. In some examples, a client device may be a set-top box that is connected to a display device, such as a television (or a television that may have set-top box circuitry built into the television mainframe).

Client devices 102, 104, and 106 may be configured to run software that allows a user to access the TSB optimization system, record with a TSB media content from a live channel, and optimize storage resources of an MDU. Client devices 102, 104, and 106 may access the TSB optimization system and the content data through the networks. The data may be stored locally on the client device or run remotely via network(s) 108. For example, a client device may receive a signal from broadcast tower 122 containing content data. The signal may indicate the content data. The client device may receive this content data and subsequently store this data locally in databases 110, 112, and/or 114. In alternative scenarios, the user requested content data may be transmitted from a client device (e.g., client device 102, 104, and/or 106) via network(s) 108 to be stored remotely on server(s) 116, 118, and/or 120. A user may subsequently access the content data from a local database (110, 112, and/or 114) and/or external database (116, 118, and/or 120), depending on where the content data may be stored. The system may be configured to receive TSB usage data and perform an analysis, to determine the channel(s) that the user utilizes the TSB and how to optimize the storage resources of the TSB at an MDU, in the background.

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to check for the content data from a channel from an OTA antenna (e.g., antenna 104). A graphical user interface may display on the mobile device 102 the feature and/or notification data. Specifically, at a particular geolocation, the antenna 104 may receive signals from broadcast tower 122. The antenna 104 may then transmit those signals for analysis via network(s) 108. The results of the analysis may then be displayed on mobile device 102 via network(s) 108. In other examples, the results of the analysis may be displayed on a television device connected to a broadcast module box, such as broadcast module box 106. In some embodiments, server(s) 116, 118, and/or 120 are be configured to support determining the channel(s) that the user utilizes a TSB and how to optimize the storage resources of the TSB at an MDU.

In other examples, databases stored on remote servers 116, 118, and 120 may be utilized to assist the system in providing a user access to the TSB optimization system. Such databases may contain certain content data, such as user behavior data, historical data, content type data, timing data, or storage device data. Such data may be transmitted via network(s) 108 to client devices 102, 104, and/or 106 to assist in determining the channel(s) that the user utilizes the TSB and how to optimize the storage resources of the TSB at an MDU. Because broadcast tower 122 and network(s) 108 are configured to communicate with one another, the systems and methods described herein may be able to identify content data in different sources, such as streaming services, local and cloud storage, cable, satellite, or OTA.

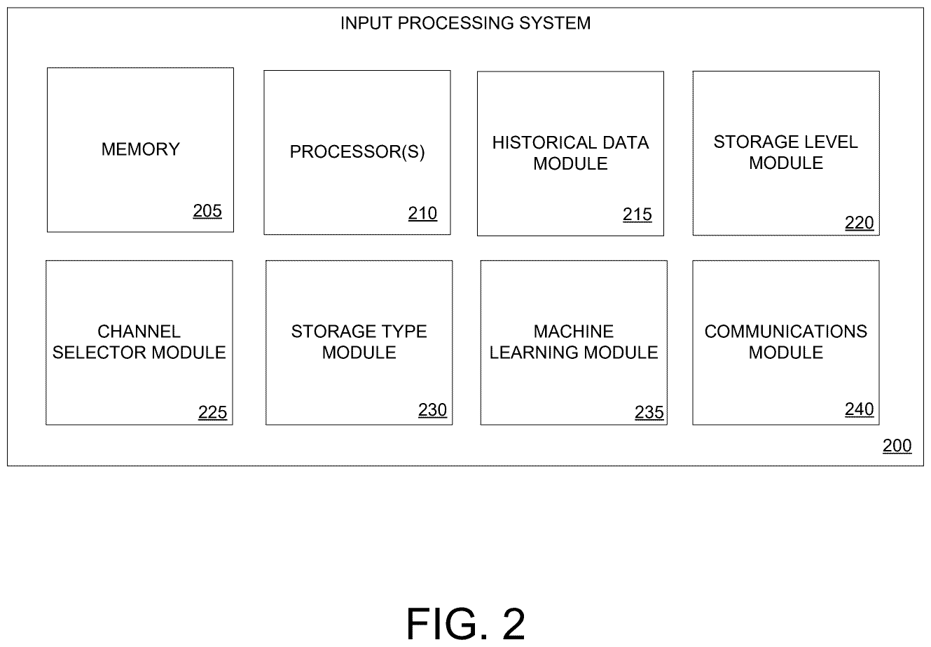

FIG. 2 illustrates an example input processing system for implementing systems and methods for time shift buffer optimization, in accordance with one or more embodiments of the present technology. The input processing system 200 (e.g., one or more data processors) is capable of executing algorithms, software routines, and/or instructions based on processing data provided by a variety of sources related to TSB optimization. The input processing system can be a general-purpose computer or a dedicated, special-purpose computer. According to the embodiments shown in FIG. 2, the disclosed system can include memory 205, one or more processors 210, historical data module 215, storage level module 220, channel selector module 225, storage type module 230, machine learning module 235, and communications module 240. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module. The input processing system 200 can be performed by a server or a user device.

Memory 205 can store instructions for running one or more applications or modules on processor(s) 210. For example, memory 205 could be used in one or more embodiments to house all or some of the instructions needed to execute the functionality of historical data module 215, storage level module 220, channel selector module 225, storage type module 230, machine learning module 235, and communications module 240. Generally, memory 205 can include any device, mechanism, or populated data structure used for storing information. In accordance with some embodiments of the present disclosures, memory 205 can encompass, but is not limited to, any type of volatile memory, nonvolatile memory, and dynamic memory. For example, memory 205 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205. In some example aspects, memory 205 may store at least one database containing the content information, historical content consumption information, channel information, user behavioral information, user information, storage information, TSB data, and any information associated with the TSB optimization system.

Historical data module 215 may be configured to analyze the TSB activity history of the user. The TSB activity history can include the type of content, when the TSB was used, how often the TSB is used, the number of channels that a TSB is used for, the type of channels that the TSB is used, time of year when a type of content is recorded to the TSB, watching patterns of the user, or any characteristics that identify the type of content/channel consumed by the user and when the TSB is used by the user. In a first example, the TSB activity history indicates that a user utilizes the TSB when watching a Monday night football game. In a second example, the TSB activity history indicates that the user utilizes the TSB for every channel that is watched. In a third example, the TSB activity history indicates that the user utilizes the TSB less than a threshold number (e.g., 3, 4, or any number) of times when watching a particular channel. In a fourth example, the TSB activity history indicates that the user utilizes the TSB more than a threshold number (e.g., 3, 4, or any number) of times when watching a particular channel. By analyzing the TSB activity history, the historical data module 215 can analyze a user's behavior of utilizing the TSB to develop a user pattern and predict the likelihood of a user utilizing a TSB for one or channels.

Storage level module 220 may be configured to determine the storage amount allocated for the user. The storage allocation can be based on the storage capability of the TSB storage device. In some embodiments, the TSB storage device connects to a server to receive additional storage resources from the server. The storage amount can include the storage resources of the hard drive of the TSB storage device and/or the storage resources provided by the server connected to the TSB storage device. In some embodiments, the storage allocation for a user is based on a subscription of the user. In some embodiments, due to legal requirements associated with storing recorded media content or the TSB storage device(s) being at a multi-dwelling unit (MDU), the storage resources are limited to on-premises servers and the local storage of the hard drive. The storage level module 220 can monitor the available storage resources at the on-premises server and allocate portions of the storage resources to users at an MDU. In some embodiments, the TSB storage device connects to cloud-based storage resources to increase the storage capability for the user. The storage level module 220 determines the current storage level of the recorded content in the TSB storage device. The current storage level of the storage device can be determined based on the size of the recorded content files in relation to the capacity of the hard drive and other storage resources accessible to the TSB storage device.

Channel selector module 225 may be configured to identify the channels that a user utilizes a TSB when watching the channel. The channel selector module 225 can select a channel based on the type of content on the channel. For example, if the user watches football via a first sport channel, the channel selector module 225 selects other sport channels that present football. If the user has a history or pattern of consuming content on a particular channel, the channel selector module 225 can pre-record content to the TSB. For example, if the user regularly watches the history channel at 8 PM on Wednesday, the channel selector module 225 pre-records content from the history channel to the TSB, starting at 8 PM just in case the user begins watching the channel later than 8 PM.

Storage type module 230 may be configured to determine the type of storage for the TSB based on the activity level of the user. The type of storage can include a conventional hard disk, a solid-state drive (SSD), a hard disk drive (HDD), a USB, or any type of storage. Due to differing costs and levels of performance associated with each type of storage, the TSB optimization system can assign different types of storage to each user in a MDU based on the activity level of each user. In a first example, if the user is an active user, such as predicted to daily use the TSB, the storage type module 230 assigns SSDs to the active user for a better TSB storage experience. In a second example, if the user is an inactive user, such as predicted to use the TSB once or twice a month, the storage type module 230 assigns HDDs to the inactive user as a cost-effective storage option.

Machine learning module 235 may be configured to predict the channel(s) that a user utilizes a TSB and determine how to optimize the storage resources of the TSB at an MDU. The machine learning module 235 may be configured to analyze TSB historical data, determine which channels the user will utilize the TSB, and determine how to optimize the storage resources available to the TSB based on at least one machine-learning algorithm trained on at least one dataset reflecting user selected channels and TSB storage allocation. The at least one machine-learning algorithms (and models) may be stored locally at databases and/or externally at databases (e.g., cloud databases and/or cloud servers). Client devices (e.g., personal computers, smart phones, tablets, etc.) may be equipped to access these machine learning algorithms and intelligently analyze TSB data and determine how to optimize storage resources at an MDU based on at least one machine-learning model that is trained on historical TSB storage optimization strategies. For example, TSB usage history of a user may be collected to train a machine-learning model to automatically select and determine which channels a user will utilize a TSB when consuming content on the channel.

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process historical TSB data and other data stores (e.g., DVR databases, server storage resources, surveys, etc.) to predict which channels a user will utilize a TSB and determine how to optimize the storage resources of the TSB at an MDU. Based on an aggregation of data from a TSB database, external/internal portals, user behavioral databases, and other user data stores, at least one ML model may be trained and subsequently deployed to automatically predict which channels a user will utilize a TSB and determine how to optimize the storage resources of the TSB at an MDU. The trained ML model may be deployed to one or more devices. As a specific example, an instance of a trained ML model may be deployed to a server device and to a client device. The ML model deployed to a server device may be configured to be used by the client device when, for example, the client device is connected to the internet. Conversely, the ML model deployed to a client device may be configured to be used by the client device when, for example, the client device is not connected to the internet. In some instances, a client device may not be connected to the internet but still configured to receive satellite signals with connectivity information. In such examples, the ML model may be locally cached by the client device.

Communications module 240 is associated with sending/receiving information (e.g., historical data module 215, storage level module 220, channel selector module 225, storage type module 230, and machine learning module 235) with a remote server or with one or more client devices, databases, routers, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 240 sends historical recording data identified by the historical data module 215, storage information identified by storage level module 220, selected channels identified by the channel selector module 225, and storage type identified by the storage type module 230.

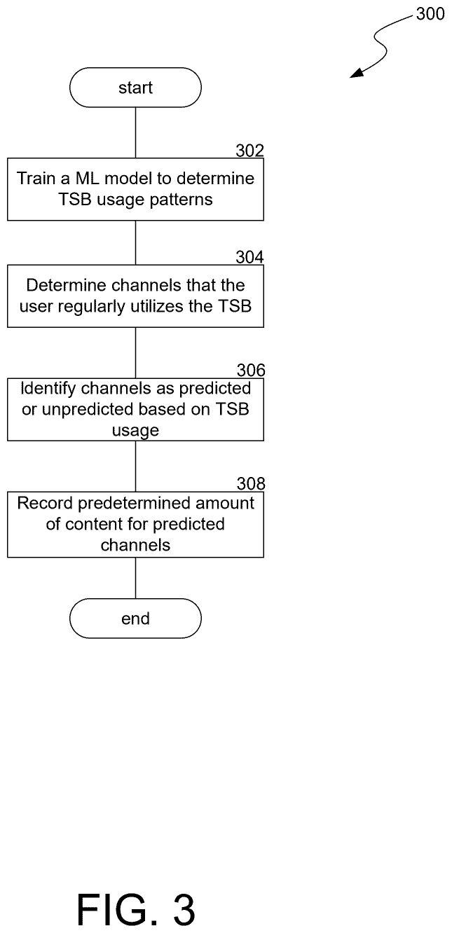

FIG. 3 is a flow diagram illustrating a process used in some implementations for training a machine learning model to determine TSB operations, in accordance with one or more embodiments of the present technology. In some implementations, process 300 is triggered by a user activating a TSB optimization application, powering on a device, receiving a command from a device, recording content to a TSB storage device, or the user downloading an application on a device to access the TSB optimization system. In various implementations, some or all of process 300 is performed locally on the user device or performed by cloud-based device(s) that can provide/support the TSB optimization system.

At step 302, the TSB optimization system trains a machine learning model to determine TSB usage patterns. The TSB optimization system can utilize various types of machine learning models, algorithms, and techniques determine to TSB usage patterns. The machine learning model can include TinyML to reduce power consumption during operations. In some embodiments, the machine learning model is initially trained on a training data set, which is a set of examples used to fit the parameters (e.g., weights of connections between “neurons” in artificial neural networks) of the model. For example, the training data set can include historical TSB data.

In some embodiments, the machine learning model (e.g., a neural network or a naïve Bayes classifier) may be trained on the training data set using a supervised learning method (e.g., gradient descent or stochastic gradient descent). The training data set can include pairs of generated “input vectors” with the associated corresponding “answer vector” (commonly denoted as the target). The current model is run with the training data set and produces a result, which is then compared with the target, for each input vector in the training data set. Based on the result of the comparison and the specific learning algorithm being used, the parameters of the model are adjusted. The model fitting can include both variable selection and parameter estimation. The fitted model can be used to predict the responses for the observations in a second data set called the validation data set. The validation data set can provide an unbiased evaluation of a model fit on the training data set while tuning the model parameters. Validation data sets can be used for regularization by early stopping, e.g., by stopping training when the error on the validation data set increases, as this may be a sign of overfitting to the training data set. In some embodiments, the error of the validation data set error can fluctuate during training, such that ad-hoc rules may be used to decide when overfitting has truly begun. Finally, a test data set can be used to provide an unbiased evaluation of a final model fit on the training data set.

To determine TSB usage patterns and predict when a user will utilize a TSB, historical TSB data can be input into the trained machine learning model(s). Additional data, such as user behavioral data, storage data of other storage devices, channel data, user data from other users within the same demographic of the user, or user data from users within the same multi-dwelling unit (MDU), can also be input into the trained machine learning model(s). The trained machine learning model(s) can then predict the channels the user will utilize the TSB in the future and when the user will utilize the TSB. Based on these predictions, the trained machine learning model(s) can determine how many users in an MDU can use a TSB based on the available storage resources to the MDU. In embodiments where multiple trained machine learning models are used, the models can be run sequentially or concurrently to compare outcomes and can be periodically updated using training data sets.

At step 304, the TSB optimization system analyzes the TSB usage history determine on which channels a user regularly utilizes the TSB. The TSB usage history can include the type of content, when the TSB is used, how long a channel is paused, how many times a TSB is used during a time period, channel watching patterns of the user, times of the day/month/year that the TSB is used, or any characteristics of when or how often a TSB is used. In a first example, the TSB usage history indicates that a user utilizes the TSB when watching content on a particular type (e.g., sports, TV, movie, etc.) of channel. In a second example, the TSB usage history indicates that the user utilizes the TSB on every channel that they watch. In a third example, the TSB usage history indicates that the user utilizes the TSB on particular days (e.g., Sunday, Monday, etc.) of the week. In a fourth example, the TSB usage history indicates the user utilized the TSB for a first type of content (e.g., hockey) on a channel but does not use the TSB on a second type of content (e.g., basketball) on the channel. By analyzing the TSB usage history, the TSB optimization system can use a user's behavior of utilizing a TSB to develop a user pattern and predict on which channels and when a user will utilize the TSB.

At step 306, the TSB optimization system identifies available channels to the user as predicted or unpredicted channels based on TSB usage history. The TSB optimization system can label a channel as “predicted” if the ML model determines the user will likely use the TSB on the channel. The TSB optimization system can label a channel as “unpredicted” if the ML model determines the user is unlikely to use the TSB on the channel.

At step 308, the TSB optimization system records a predetermined amount of content for predicted channels. The TSB optimization system can start recording content on a predicted channel a time amount (e.g., 30 minutes, 60 minutes, etc.) prior to when the user is predicted to tune a television receiver to the channel and being watching content on the channel. For example, if a user is predicted to watch a sporting event on a channel at 7 PM, prior to the user tuning a television receiver to the channel, the TSB optimization system begins recording content at 6:30 PM so the user can watch the opening ceremony.

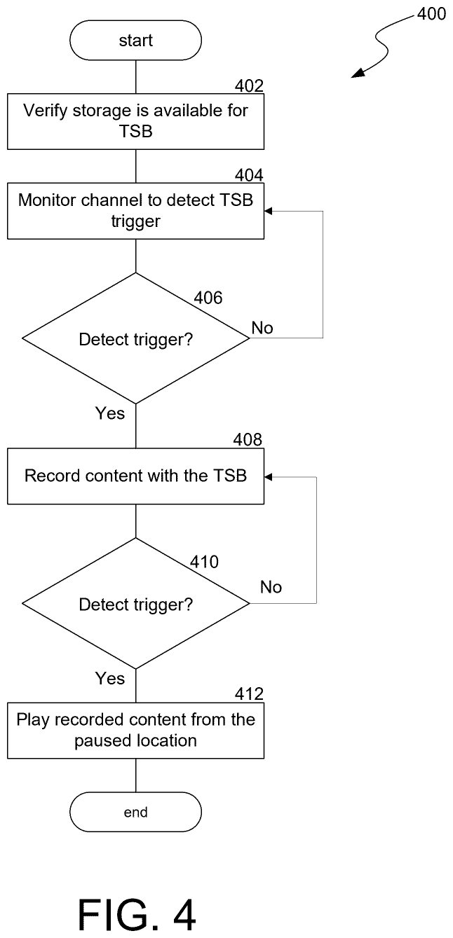

FIG. 4 is a flow diagram illustrating a process used in some implementations for operating a time shift buffer, in accordance with one or more embodiments of the present technology. In some implementations, process 400 is triggered by a user activating a TSB optimization application, powering on a device, receiving a command from a device, recording content to a TSB storage device, or the user downloading an application on a device to access the TSB optimization system. In various implementations, some or all of process 400 is performed locally on the user device or performed by cloud-based device(s) that can provide/support the TSB optimization system.

At step 402, the TSB optimization system verifies that there is available storage for the TSB at the MDU. The TSB optimization system can verify that there is a threshold amount of storage resources available to operate the TSB. The TSB device can connect to a server (e.g., an on-premises server at the MDU) to receive additional storage resources from the server. The available storage can include the storage resources of the hard drive of the TSB device and/or the storage resources provided by the server connected to the TSB device. In some embodiments, the storage available to the TSB device is based on a subscription of the user. In some embodiments, due to legal requirements associated with storing recorded media content or the TSB optimization system being associated with an MDU, the storage resources are limited to on-premises servers and the local storage of the hard drive. The TSB optimization system can monitor the available storage resources at the on-premises server and allocate portions of the storage resources to users at the MDU. In some embodiments, the TSB device connects to cloud-based storage resources to increase the storage capability for the user.

At step 404, the TSB optimization system monitors a channel to detect a TSB trigger. The trigger can include the user pressing a button (e.g., pause button) on a device to pause the content which triggers the TSB to record the content from the channel. In some embodiments, the TSB optimization system uses a camera or microphone to detect a gesture, action, or voice command of the user as the trigger. For example, if the user walks away from a display device, the TSB optimization system automatically pauses the content and begins recording the content until the user returns.

At step 406, the TSB optimization system determines if the trigger was detected to begin recording the content from the channel with the TSB. If the trigger was detected, at step 408, the TSB optimization system records content with the TSB. If the trigger was not detected, the TSB optimization system continues to monitor the channel.

At step 410, the TSB optimization system determines if the trigger was detected to stop recording the content from the channel with the TSB. The trigger can include the user pressing a button (e.g., play button) on a device which triggers the TSB to play the recorded content from the channel. In some embodiments, the TSB optimization system uses a camera or microphone to detect a gesture, action, or voice command of the user as the trigger. For example, if the user returns to a display device, the TSB optimization system automatically plays the content. If the trigger was detected, at step 412, the TSB optimization system can continue to record content to the TSB even when user starts playing from the paused location. For example, while the channel is paused, the content provider will continue to broadcast live content and the user will be behind the live edge of the broadcast. If the trigger was not detected, the TSB optimization system continues to record content from the channel with the TSB.

The TSB optimization system can maintain a buffer amount (e.g., 1 hour of content) of recorded content while the user watches a channel. For example, the TSB optimization system maintains an hour of recorded content on the TSB device while the user is consuming content on a channel. The TSB optimization system can delete consumed content from the TSB storage and delete content outside of the buffer amount. By deleting the content from the TSB storage, the TSB optimization system frees up memory and increases operating speeds of the devices. Additionally, at an MDU, by optimizing storage resources by deleting content, more users are able to participate in a TSB system.

In some implementations, the TSB optimization system may employ various strategies to delete content from the TSB and optimize storage resources. The system may prioritize deletion of content that has already been viewed by the user, content that exceeds a predetermined age threshold, or content from channels that the user rarely accesses. Additionally, the system may analyze viewing patterns to identify low-priority content that can be removed with minimal impact on user experience. In some cases, the TSB optimization system may compress older content to reduce storage requirements while still maintaining accessibility. The system may also implement a sliding window approach, automatically deleting the oldest content as new content is recorded, ensuring a consistent amount of recent content is always available. By intelligently managing content deletion, the TSB optimization system may maximize available storage space, improve system performance, and enhance the overall user experience, particularly in multi-dwelling unit environments where storage resources may be shared among multiple users.

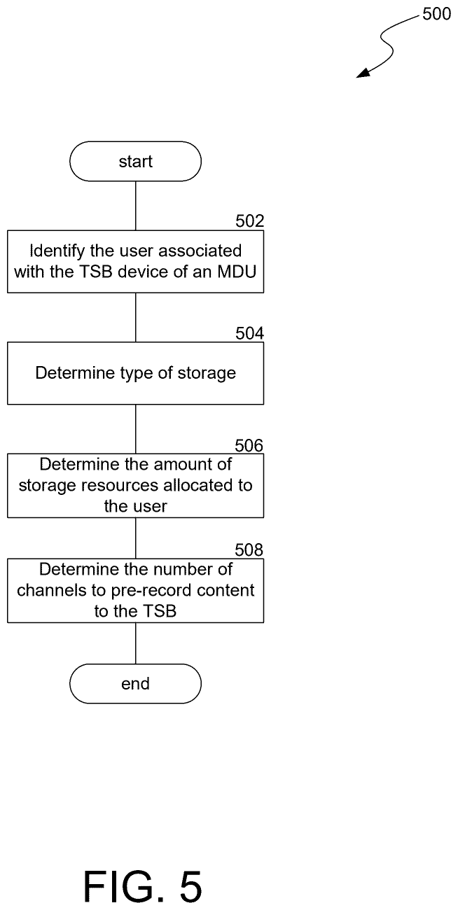

FIG. 5 is a flow diagram illustrating a process used in some implementations for determining the amount of storage for a time shift buffer, in accordance with one or more embodiments of the present technology. In some implementations, process 500 is triggered by a user activating a TSB optimization application, powering on a device, receiving a command from a device, recording content to a TSB storage device, or the user downloading an application on a device to access the TSB optimization system. In various implementations, some or all of process 500 is performed locally on the user device or performed by cloud-based device(s) that can provide/support the TSB optimization system.

At step 502, the TSB optimization system identifies the user associated with the TSB device of an MDU based on user credentials, user location, TSB device identifier information, or any user account information. The TSB optimization system can identify the user to differentiate the user from other users in an MDU. In some embodiments, users associated with an MDU share TSB storage resources provided by a server connected to the TSB devices at the MDU. For example, a server provides additional storage to each user's TSB to increase the storage capability for each user at the MDU.

The TSB optimization system can determine the activity level of the TSB device by the user. The activity level can include the frequency that the user utilizes the TSB while consuming content on a channel. For example, a user who utilizes the TSB daily has a high activity level, a user who utilizes the TSB weekly has a medium activity level, and a user who utilizes the TSB monthly has a low activity level. The activity level can include the number of channels that the user utilizes the TSB and/or how often the user utilizes the TSB on each channel.

At step 504, the TSB optimization system determines the type of storage for the TSB to provide to the user based on the identity and/or the activity level of the user. The type of storage can include a conventional hard disk, a solid-state drive (SSD), a hard disk drive (HDD), a USB, or any type of storage. Due to differing costs and levels of performance associated with each type of storage, the TSB optimization system can assign different types of storage to each user in a MDU based on the activity level or identity of each user. In a first example, if the user is an active user, such as predicted to daily utilize the TSB, the TSB optimization system assigns SSDs to the active user for a better storage experience. In a second example, if the user is an inactive user, such as predicted to monthly utilize the TSB, the TSB optimization system assigns HDDs to the inactive user as a cost-effective storage option. The TSB optimization system can determine the type of storage for the TSB based on a subscription or premium paid by the user for TSB storage. For example, for a premium paid active user, the TSB optimization system assigns SSD or nonvolatile memory express (NVME) storage to the user for better optimized user experience.

At step 506, the TSB optimization system determines the amount of storage resources allocated to the user based on the type of storage, activity level of the user, identity of the user, and/or subscription of the user. The storage resources can include the hard drive of the TSB device and/or storage resources at an MDU, such as an on-premises server.

At step 508, the TSB optimization system determines the number of channels to pre-record content to the TSB based on the amount of storage resources allocated to the user at the MDU. The TSB optimization system may determine which channels to pre-record content to the TSB based on various factors. In some aspects, the system may analyze the user's viewing history, preferences, and TSB usage patterns to identify channels that are likely to be watched by the user. The system may also consider the current time, day of the week, and upcoming programming schedules to prioritize channels for pre-recording. In some cases, the system may take into account the popularity of certain shows or events across multiple users in the MDU to optimize storage allocation. The TSB optimization system may also consider the available storage resources and balance the number of pre-recorded channels against the storage capacity. Additionally, the system may adapt its pre-recording strategy based on real-time user behavior, such as channel surfing patterns or recent changes in viewing habits. By intelligently selecting which channels to pre-record, the TSB optimization system may enhance the user experience while efficiently managing storage resources in the MDU environment.

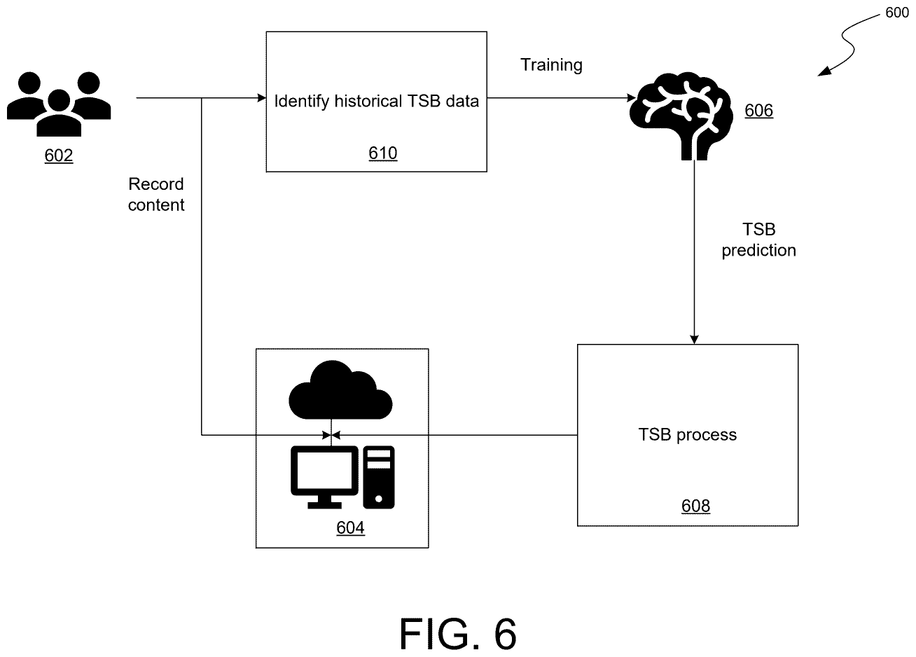

FIG. 6 is a diagram illustrating an example system for optimizing time shift buffer operations, in accordance with one or more embodiments of the present technology. System 600 can identify when users 602 utilize a TSB device 604 (e.g., a TSB connected to a storage device, a server, and/or a cloud-based device). The system 600 maintains a history of the TSB data and predicts the type of content, type of channel, and time when the users 602 will utilize a TSB while consuming content on a channel. For example, the historical TSB data indicates which channels a TSB is used, how often the TSB is used, how frequently the TSB is used, and how many users in an MDU utilize a TSB.

System 600 trains machine learning model(s) 606 with the historical TSB data 610 to perform the TSB process 608, to predict the channel(s) that a user utilizes a TSB device 604, and determine how to optimize the storage resources of the TSB at an MDU. The machine learning model 606 can generate TSB prediction data to predict when the user will use a TSB, which channels the user will utilize the TSB, and the amount of storage resources that will be used.

Based on the TSB prediction data, system 600 determines how to optimize the storage resources of the TSB at an MDU. For example, system 600 performs any of the steps of FIGS. 3-5 to predict TSB usage and allocate storage resources at the MDU. Once content is deleted from the TSB device 604, system 600 continues to monitor the TSB data of the users 602.

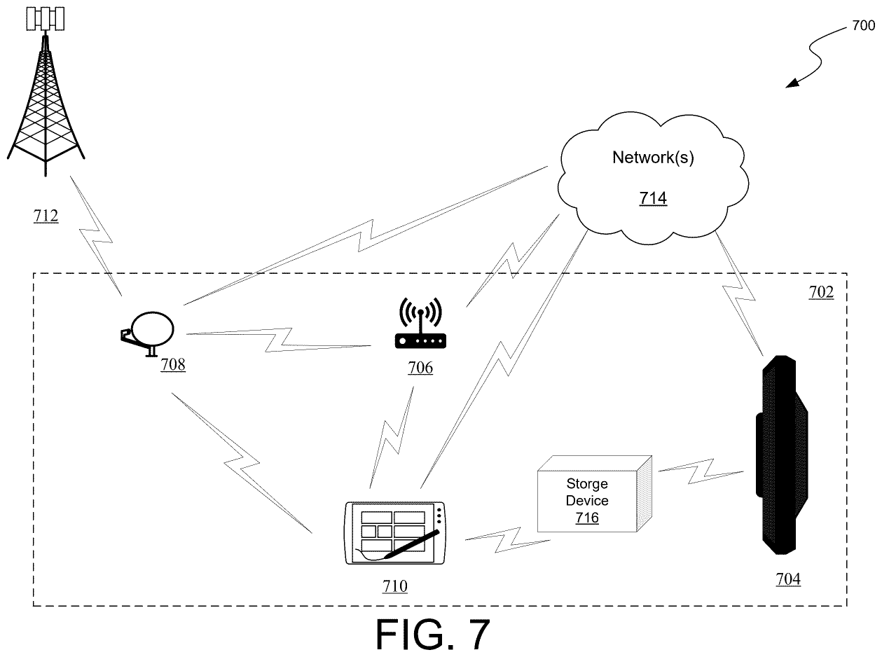

FIG. 7 illustrates an example environment of operation of the disclosed technology. In the example environment 700 illustrated in FIG. 7, area 702 may represent a house, a commercial building, an apartment, a condo, or any other type of suitable dwelling. Inside area 702 is at least one television 704, an OTA box 706 (e.g., broadcast module box, such as a set-top box)), an OTA antenna 708, and a mobile device 710. Each of these devices may be configured to communicate with network(s) 714. OTA box 706 may be configured as a central gateway communicable with various multimedia content providers and devices, among other servers and databases housing multimedia content available for retrieval and display on user devices. OTA box 706, mobile device 710, and television 704 may participate in the TSB optimization system and communicate with storage device 716 (e.g., a DVR device). Network(s) 714 may be a WiFi network and/or a cellular network. The OTA antenna 708 may also be configured to receive local broadcast signals from local broadcast tower 712 or satellite broadcast tower.

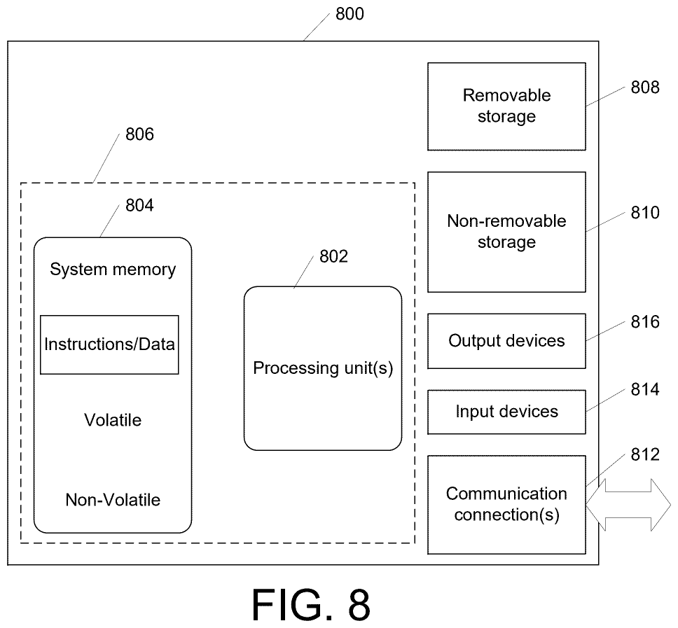

FIG. 8 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 800 typically includes at least one processing unit 802 and memory 804. Depending on the exact configuration and type of computing device, memory 804 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 8 by dashed line 806. Further, environment 800 may also include storage devices (removable 808 and/or non-removable 810) including, but not limited to, magnetic or optical disks or tape. Similarly, environment 800 may also have input device(s) 814 such as keyboard, mouse, pen, voice input, etc., and/or output device(s) 816 such as a display, speakers, printer, etc. Also included in the environment may be one or more communication connections, 812, such as Bluetooth, WiFi, WiMax, LAN, WAN, point to point, etc.

Operating environment 800 typically includes at least some form of computer readable media. Computer readable media can be any available media that can be accessed by processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 800 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively.

Several implementations of the disclosed technology are described above in reference to the figures. The computing devices on which the described technology may be implemented can include one or more central processing units, memory, user devices (e.g., keyboards and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A method for optimizing storage resources at a multi-dwelling unit (MDU), the method comprising:
determining historical usage data of a time shift buffer (TSB) associated with a user;
predicting at least one channel from which the user will store video content in the TSB by analyzing the historical usage data of the TSB;
determining an activity level of the user utilizing the TSB based on the historical usage data;
selecting a storage type of storage resources accessible to the TSB at the MDU based on the activity level of the user; and
storing content from the at least one channel to a storage resource of the storage type prior to the user tuning a television receiver to the at least one channel.

2. The method of claim 1, further comprising:
monitoring the at least one channel to detect a TSB trigger; and
in response to detecting the TSB trigger, recording content from the at least one channel to the storage resource of the storage type.

3. The method of claim 1, further comprising:
determining the storage resources accessible to the TSB include a storage device connected to an on-premises server at the MDU;
determining a storage capacity at the on-premises server allocated for the user; and
determining an amount of the storage resources available to the user based on storage resources locally available on the storage device and based further upon the storage capacity at the on-premises server allocated for the user.

4. The method of claim 1, further comprising:
deleting stored content from the storage resource, wherein deleting the stored content includes:
identifying consumed content that has been consumed by the user;
determining a storage duration for the consumed content; and
removing the consumed content from the storage resource based on the storage duration exceeding a threshold value.

5. The method of claim 1, the method further comprising:
determining a predicted start time when the user is likely to begin watching the at least one channel based on the historical usage data; and
initiating the storing of content from the at least one channel at a predetermined time interval before the predicted start time.

6. The method of claim 1, wherein the at least one channel is identified by at least one machine-learning algorithm, wherein the at least one machine-learning algorithm is trained based on at least one dataset associated with previously identified channels.

7. The method of claim 1, the method further comprising:
determining a total storage capacity available for TSB operations at the MDU;
analyzing TSB usage patterns across multiple users at the MDU;
dynamically allocating portions of the total storage capacity to individual users based on respective activity levels and predicted TSB usage; and
periodically adjusting the allocated portions for each user to optimize overall storage utilization at the MDU.

8. A system comprising:
one or more processors; and
one or more memories storing instructions that, when executed by the one or more processors, cause the system to perform a process for optimizing storage resources at a multi-dwelling unit (MDU), the process comprising:
determining historical usage data of a time shift buffer (TSB) associated with a user;
predicting at least one channel from which the user will store video content in the TSB by analyzing the historical usage data of the TSB;
determining an activity level of the user utilizing the TSB based on the historical usage data;
selecting a storage type of storage resources accessible to the TSB at the MDU based on the activity level of the user; and
storing content from the at least one channel to a storage resource of the storage type prior to the user tuning a television receiver to the at least one channel.

9. The system of claim 8, wherein the process further comprises:
monitoring the at least one channel to detect a TSB trigger; and
in response to detecting the TSB trigger, recording content from the at least one channel to the storage resource of the storage type.

10. The system of claim 8, wherein the process further comprises:
determining the storage resources accessible to the TSB include a storage device connected to an on-premises server at the MDU;
determining a storage capacity at the on-premises server allocated for the user; and
determining an amount of the storage resources available to the user based on storage resources locally available on the storage device and based further upon the storage capacity at the on-premises server allocated for the user.

11. The system of claim 8, wherein the process further comprises:
deleting stored content from the storage resource, wherein deleting the stored content includes:
identifying consumed content that has been consumed by the user;
determining a storage duration for the consumed content; and
removing the consumed content from the storage resource based on the storage duration exceeding a threshold value.

12. The system of claim 8, wherein the process further comprises:
determining a predicted start time when the user is likely to begin watching the at least one channel based on the historical usage data; and
initiating the storing of content from the at least one channel at a predetermined time interval before the predicted start time.

13. The system of claim 8, wherein the at least one channel is identified by at least one machine-learning algorithm, wherein the at least one machine-learning algorithm is trained based on at least one dataset associated with previously identified channels.

14. The system of claim 8, wherein the process further comprises:
determining a total storage capacity available for TSB operations at the MDU;
analyzing TSB usage patterns across multiple users at the MDU;
dynamically allocating portions of the total storage capacity to individual users based on respective activity levels and predicted TSB usage; and
periodically adjusting the allocated portions for each user to optimize overall storage utilization at the MDU.

15. A non-transitory computer-readable medium storing instructions that, when executed by a computing system, cause the computing system to perform operations for optimizing storage resources at a multi-dwelling unit (MDU), the operations comprising:
determining historical usage data of a time shift buffer (TSB) associated with a user;
predicting at least one channel from which the user will store video content in the TSB by analyzing the historical usage data of the TSB;
determining an activity level of the user utilizing the TSB based on the historical usage data;
selecting a storage type of storage resources accessible to the TSB at the MDU based on the activity level of the user; and
storing content from the at least one channel to a storage resource of the storage type prior to the user tuning a television receiver to the at least one channel.

16. The non-transitory computer-readable medium of claim 15, wherein the operations further comprise:
monitoring the at least one channel to detect a TSB trigger; and
in response to detecting the TSB trigger, recording content from the at least one channel to the storage resource of the storage type.

17. The non-transitory computer-readable medium of claim 15, wherein the operations further comprise:
determining the storage resources accessible to the TSB include a storage device connected to an on-premises server at the MDU;
determining a storage capacity at the on-premises server allocated for the user; and
determining an amount of the storage resources available to the user based on storage resources locally available on the storage device and based further upon the storage capacity at the on-premises server allocated for the user.

18. The non-transitory computer-readable medium of claim 15, wherein the operations further comprise:
deleting stored content from the storage resource, wherein deleting the stored content includes:
identifying consumed content that has been consumed by the user;
determining a storage duration for the consumed content; and
removing the consumed content from the storage resource based on the storage duration exceeding a threshold value.

19. The non-transitory computer-readable medium of claim 15, wherein the operations further comprise:
determining a predicted start time when the user is likely to begin watching the at least one channel based on the historical usage data; and
initiating the storing of content from the at least one channel at a predetermined time interval before the predicted start time, wherein the at least one channel is identified by at least one machine-learning algorithm, wherein the at least one machine-learning algorithm is trained based on at least one dataset associated with previously identified channels.

20. The non-transitory computer-readable medium of claim 15, wherein the operations further comprise:
determining a total storage capacity available for TSB operations at the MDU;
analyzing TSB usage patterns across multiple users at the MDU;
dynamically allocating portions of the total storage capacity to individual users based on respective activity levels and predicted TSB usage; and
periodically adjusting the allocated portions for each user to optimize overall storage utilization at the MDU.
